(19) United States
(12) Patent Application Publication
(10) Pub. No.: US 2026/0080709 A1
(43) Pub. Date: Mar. 19, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: YOSHITAKA MATSUMOTO, Kanagawa (JP)

(21) Appl. No.: 19/327,688

(22) Filed: Sep. 12, 2025

(30) Foreign Application Priority Data
Sep. 17, 2024 (JP) 2024-160102

(51) Int. Cl. G06V 30/416; G06F 16/16; G06V 10/70; G06V 30/19; G06V 30/24; H04N 1/00; H04N 1/21

(52) U.S. Cl. CPC G06V 30/416; G06F 16/164; G06V 10/70; G06V 30/19; G06V 30/24; H04N 1/00331; H04N 1/2166; H04N 2201/0094

(57) ABSTRACT

An image processing apparatus is an image processing apparatus that generates property information of a scanned image obtained by scanning a document, including: obtaining one or more character strings obtained by character recognition processing on the scanned image; generating the property information by using a character string that meets a generation rule of the property information of the scanned image out of the obtained one or more character strings; and allowing a displaying unit to display the property information. In a case where the obtained one or more character string do not include the character string that meets the generation rule, the property information to which information indicating that the obtainment of the character string that meets the generation rule fails is added is generated.

### BACKGROUND

### Field of the Technology

The present disclosure relates to a technique of filing a scanned image.

### Description of the Related Art

In a case of filing a scanned image obtained by scanning and the like of a document such as an order form, a character string identified based on a file name generation rule from character strings extracted from the scanned image by character recognition processing (OCR processing) has been utilized as a file name and the like.

Japanese Patent Laid-Open No. 2019-115011 discloses a technique of generating a file name by extracting a character string that meets an extraction rule from a scanned image of a document, which includes a technique in a case where the character string extraction fails, in which the character string indicating a document type determined based on a size of the corresponding document is utilized as the file name instead of the extracted character string.

### SUMMARY

An image processing apparatus according to an aspect of the present disclosure is an image processing apparatus that generates property information of a scanned image obtained by scanning a document, including: obtaining a character string obtained by character recognition processing on the scanned image; generating the property information by using a character string that meets a generation rule of the property information of the scanned image out of the obtained character string; and allowing a displaying unit to display the property information, in which in a case where the obtained character string does not include the character string that meets the generation rule, in the generating, the property information to which information indicating that the obtainment of the character string that meets the generation rule fails is added is generated.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of an image processing system.

FIG. 2 is a diagram illustrating a hardware configuration example of an MFP.

FIG. 3 is a diagram illustrating a hardware configuration example of an external storage.

FIG. 4 is a diagram illustrating a software configuration example of the MFP.

FIG. 5 is a flowchart illustrating a flow of processing executed by the MFP.

FIG. 6 is a diagram illustrating a document image example.

FIG. 7 is a flowchart illustrating a detailed flow of accepting processing of confirmation and correction by a user.

FIGS. 8A to 8C are diagrams illustrating correction screen examples.

FIGS. 9A to 9D are diagrams illustrating a file name correction screen example.

FIG. 10 is a flowchart illustrating a detailed flow of the accepting processing of the confirmation and the correction of a file name.

FIG. 11 is a flowchart illustrating a detailed flow of generation processing of the file name.

FIG. 12 is a diagram illustrating a file name correction screen example.

FIG. 13 is a flowchart illustrating a detailed flow of the generation processing of the file name.

FIG. 14 is a flowchart illustrating a flow of the processing executed by the MFP.

FIG. 15 is a flowchart illustrating a detailed flow of the generation processing of the file name.

### DESCRIPTION OF THE EMBODIMENTS

Embodiments of a technique of the present disclosure are described below in detail with reference to the drawings. Note that the following embodiments are not intended to limit the technique of the present disclosure according to the scope of claims. Not all the combinations of characteristics described in the embodiments are necessarily required for the means for solving the problems of the technique of the present disclosure, and the multiple characteristics may be combined arbitrarily. Note that the same configurations are described by providing the same reference numerals. Additionally, each step in a flowchart is described by prepending “S.”

### First Embodiment

### <Overall Configuration>

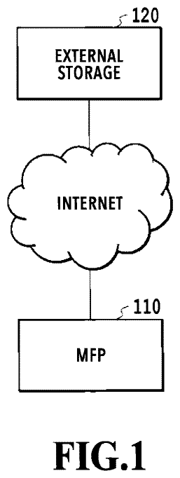

FIG. 1 is a diagram illustrating a schematic configuration example of an image processing system according to the present embodiment. The image processing system of the present embodiment includes a multifunction peripheral (MFP) 110 and an external storage 120. The MFP 110 is communicably connected to a server that provides various services on the Internet by way of a local area network (LAN).

The MFP 110 is a multifunction peripheral having multiple functions of a scanner, a printer, and the like and is an example of an information processing apparatus. The MFP 110 also has a function of transferring a file of a scanned image obtained by scanning a document to an external storage and the like that into which the file can be saved. Note that the information processing apparatus of the present embodiment is not limited to the multifunction peripheral including the scanner and the printer and may be a personal computer (PC) or the like.

The external storage 120 executes a service that allows for saving of various data such as the file of the scanned image received via the Internet and obtainment of the file from an external apparatus via a web browser. The external storage 120 is a cloud service, for example. The number of the external storage 120 is not limited to one and there may be multiple external storages 120.

The image processing system of the present embodiment is a configuration including the MFP 110 and the external storage 120; note that it is not limited thereto. For example, a part of the function and the processing of the MFP 110 may be executed by another server arranged on the Internet and the LAN. Additionally, the external storage 120 may be arranged on the LAN instead of the Internet. Moreover, the external storage 120 may be replaced with an e-mail server or the like and may attach the file of the scanned image obtained by scanning the document to an e-mail and transmit the e-mail. The MFP 110 may also have the saving function of the external storage 120.

### <Hardware Configuration of MFP>

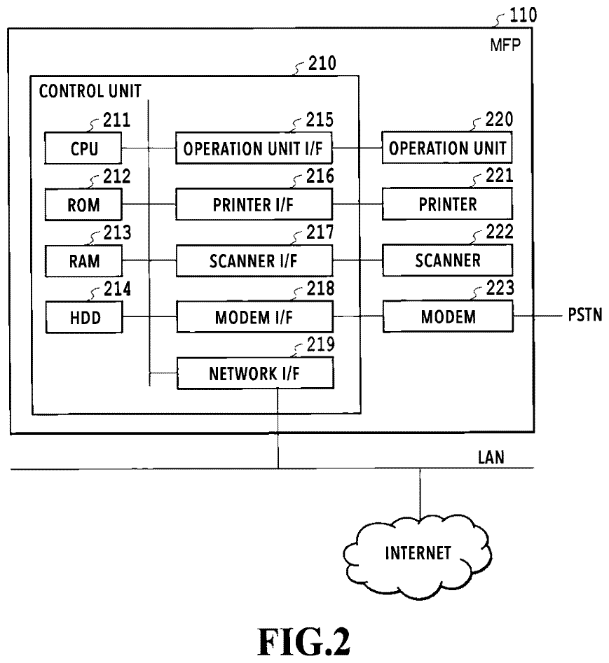

FIG. 2 is a diagram illustrating a hardware configuration example of the MFP 110. The MFP 110 includes a control unit 210, an operation unit 220, a printer 221, a scanner 222, and a modem 223. The control unit 210 includes a CPU 211, a ROM 212, a RAM 213, an HDD 214, an operation unit I/F 215, a printer I/F 216, a scanner I/F 217, a modem I/F 218, and a network I/F 219.

The CPU 211 controls an operation of overall the MFP 110 by reading out a control program stored in the ROM 212 and the HDD 214 to the RAM 213 to execute, and various functions of the MFP 110 such as reading/printing/communication are executed. The ROM 212 stores a program such as an OS executed by the CPU 211 to control the operation of the MFP 110, a parameter required to execute the program, and the like. The RAM 213 is used as a temporal storage region such as a main memory and a working area of the CPU 211. Note that although the single CPU 211 executes each processing illustrated in a flowchart described later by using a single storage unit (the RAM 213 or the HDD 214) in the present embodiment, it is not limited thereto. For example, multiple CPUs and multiple RAMs or HDDs may cooperate to execute each processing. The HDD 214 is a mass-storage unit that stores the image data and various programs.

The operation unit I/F 215 is an interface connecting the operation unit 220 and the control unit 210. The operation unit 220 includes a displaying device such as a liquid crystal monitor including a touch panel, a keyboard, and the like to accept an operation by the user and notify the CPU 211 of an instruction according to an input by the user operation.

The printer I/F 216 is an interface connecting the printer 221 and the control unit 210. The image data for printing is transferred to the printer 221 from the control unit 210 via the printer I/F 216 and printed on a printing medium such as a sheet in a predetermined size by the printer 221. The scanner I/F 217 is an interface connecting the scanner 222 and the control unit 210. The scanner 222 generates scanned image data by scanning the document set on a not-illustrated platen glass or automatic original document reading apparatus (auto document feeder: ADF) and inputs the scanned image data to the control unit 210 via the scanner I/F 217. The MFP 110 can perform copying to output the scanned image data generated by the scanner 222 from the printer 221 as a print product, and additionally it is possible to perform file transmission and e-mail transmission to the outside. The modem I/F 218 is an interface connecting the modem 223 and the control unit 210. The modem 223 transmits and receives the image data by facsimile communication with a not-illustrated facsimile apparatus on a public switched telephone network (PSTN). The network I/F 219 is an interface connecting the control unit 210 (the MFP 110) to the LAN. The MFP 110 can transmit the image data and the information to each service on the Internet by using the network I/F 219 and can also receive various pieces of information.

### <Hardware Configuration of External Storage>

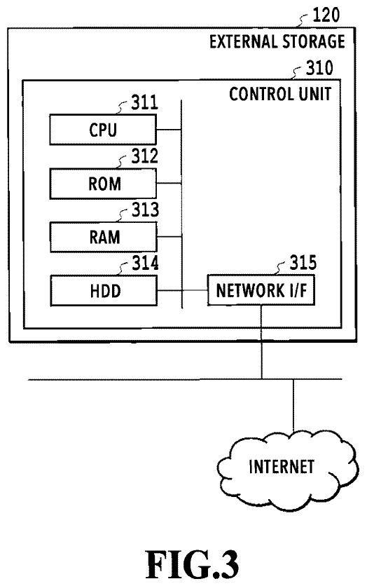

FIG. 3 is a diagram illustrating a hardware configuration example of the external storage 120. The external storage 120 includes a control unit 310. The control unit 310 includes a CPU 311, a ROM 312, a RAM 313, an HDD 314, and a network I/F 315. The CPU 311 controls an operation of overall the external storage 120 by reading out a control program stored in the ROM 312 to the RAM 313 to execute. The ROM 312 stores a program that can be executed by the CPU 311, a parameter required to execute the program, and the like. The RAM 313 is used as a temporal storage region such as a main memory and a working area of the CPU 311. The HDD 314 is a mass-storage unit that stores the image data and various programs. The network I/F 315 is an interface connecting the external storage 120 to the Internet. The external storage 120 performs processing such as transmission and reception and saving of various types of information according to a request notified by an external apparatus such as the MFP 110 via the network I/F 315.

### <Software Configuration of MFP>

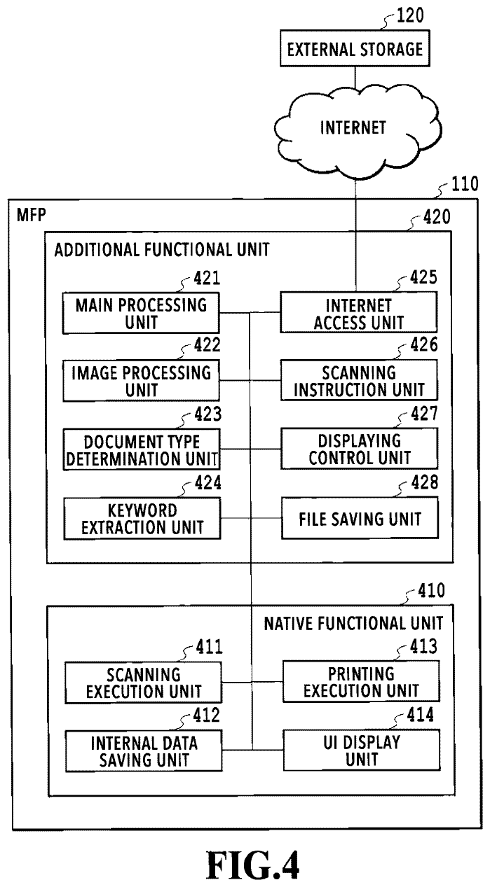

FIG. 4 is a diagram illustrating a software configuration example of the MFP. A functional block of the MFP 110 is roughly classified into two units, which are a native functional unit 410 and an additional functional unit 420. Each functional unit of the MFP 110 is implemented with the CPU 211 reading out the program stored in the ROM 212 and the HDD 214 to the RAM 213 to execute.

A scanning execution unit 411, an internal data saving unit 412, a printing execution unit 413, and a user interface (UI) display unit 414 included in the native functional unit 410 are generally included in the MFP 110. The additional functional unit 420 is an application additionally installed in the MFP 110. The additional functional unit 420 is an application based on Java (registered trademark) and can easily implement adding of a function to the MFP 110. Note that another not-illustrated application may be additionally installed in the MFP 110.

As described above, the native functional unit 410 includes the scanning execution unit 411, the internal data saving unit 412, the printing execution unit 413, and the UI display unit 414. The additional functional unit 420 includes a main processing unit 421, an image processing unit 422, a document type determination unit 423, a keyword extraction unit 424, an Internet access unit 425, a scanning instruction unit 426, a displaying control unit 427, and a file saving unit 428.

According to a scanning request, the scanning execution unit 411 generates the scanned image data by scanning the document set on the platen glass by the scanner, 222 via the scanner I/F 217. The internal data saving unit 412 saves the data to the HDD 214 and obtains the data from the HDD 214.

According to the generated image data for printing, the printing execution unit 413 executes processing of printing an image on the printing medium by the printer 221 via the printer I/F 216. The UI display unit 414 displays a UI screen on the touch panel of the operation unit 220 via the operation unit I/F 215.

The main processing unit 421 has a function of general processing of the additional functional unit 420. Specifically, the main processing unit 421 controls the overall processing of the additional functional unit 420 and requests each unit included in the additional functional unit 420 to perform processing.

The image processing unit 422 performs analysis processing on the image data. The image processing unit 422 performs processing for the image such as block selection (BS), character recognition (OCR), and rotation and inclination correction of the image on the image data. BS is an abbreviation for Block Selection, which is processing of extracting a rectangular region indicating a place of a character string from the image. OCR is an abbreviation for optical character recognition, which is processing of extracting the character string from the image.

The document type determination unit 423 determines a document type of the image data. The document type indicates a type of the document, which is an invoice, a receipt, a statement of delivery, a contract, and so on, for example. Any other types may be included

As a method of determining the document type, inference is executed by utilizing a machine learning model. The machine learning model is generated by using character string information and a correct answer label. For example, BS and OCR processing are executed based on multiple document image samples, which are document image samples such as an invoice, a quotation, and a purchase order, for example, and the character string information that is a BS/OCR result forming the document sample is obtained. A document type label indicating the document type and a keyword label indicating a company name, a document number, a person name, a phone number, an address, an amount, a date, and so on are applied to the document image sample formed of the obtained character string information. Then, the machine learning model is learned and generated by using the character string information, the document type label, and the keyword label.

The character string utilized to generate the machine learning model may be divided into words by morphological analysis, and the machine learning model may be generated by a method of utilizing the divided word. Additionally, the model may be generated by a method of Fine-tuning based on BERT and GPT that are pre-training models. Note that BERT is an abbreviation of Bidirectional Encoder Representations from Transformers. GPT is an abbreviation of Generative Pre-trained Transformers.

Additionally, the document type may be determined by generating a learned model that has learned a term that is likely to appear for each document type as a pattern and using the generated learned model. Moreover, a determination unit that has learned a layout that is likely to appear for each document type as the pattern may be used. Furthermore, the above-described units may be used in combination. Any other means may be used. Additionally, a certainty may be calculated for the determined document type. The certainty is a degree indicating how much the recognized result is certain. For example, the certainty may be expressed in percentage like 99% or may be expressed by a level like high, medium, and low. Any other expression may be applied. For example, in a case where the determination unit that determines the document type probabilistically is used, a probability value used for the determination may be calculated as the certainty, or a degree of coincidence between results determined by different multiple determination units may be calculated as the certainty. The certainty may be calculated by any other means. The certainty and the calculation method of the certainty are similar concept and calculation method also in operations other than the document type determination.

The keyword extraction unit 424 extracts a keyword from the character string. The keyword indicates a word having a particular concept that frequently appears in the document, which is the character string indicating a concept such as a company name, a document number, a person name, a phone number, an address, an amount, and a date, for example. Any other words may be included. Additionally, a word meaning a type of the keyword such as the company name, the document number, the person name, the phone number, the address, the amount, and the date is called a keyword label.

In the above-described method of extracting the keyword, inference is executed by utilizing the machine learning model as with the case of the document type. The generation method of the machine learning model is also similar to that in the case of the document type.

The extraction may be performed by an extractor that has learned a position in a context in which the keyword appears as the pattern. Additionally, the extraction may be performed by an extractor that has learned a position in the layout in which the keyword appears as the pattern. Moreover, the extraction may be performed by the above-described extractors in combination. The extractors may be used separately for each document type, or the same extractors may be used for a part of or all the document types. The extraction may be performed by any other means. The keyword that can be extracted may be different for each document type. Additionally, the certainty may be calculated for the extracted keyword.

The Internet access unit 425 transmits a processing request to a cloud service and the like that provide a storage function (a storage service). In general, the cloud service releases various interfaces that use a protocol such as REST and SOAP to save the file to the cloud storage and obtain the saved file from an external apparatus. The Internet access unit 425 operates the cloud service by using the released interface of the cloud service. The Internet access unit 425 transmits the image data to the external storage 120 via the network I/F 219.

The scanning instruction unit 426 requests the scanning execution unit 411 to perform scanning processing according to scanning setting inputted via the UI screen.

The display control unit 427 displays the UI screen to accept the operation by the user on the displaying device such as the liquid crystal monitor having the touch panel function of the operation unit 220 of the MFP 110. For example, an operation screen to accept an operation to perform scanning setting and start scanning, confirmation of a preview of the scanned image obtained by scanning the document and a file name described later, and an operation to perform output setting and start outputting is displayed. The display control unit 427 displays a component to be displayed on the screen in a coordinate position of the screen. The component to be displayed, the coordinate position, and the displaying method may be directly designated on a program code. Additionally, a method of designating as a tag language and a style sheet such as hypertext markup language (HTML) and cascading style sheets (CSS) may be applied.

The file saving unit 428 saves the image as the file by using file saving information. The file saving information is information required to save the file and includes a folder path, the file name, and the like, for example. Any other information may be included. The file saving unit 428 may save the file to the HDD 214 via the internal data saving unit 412 or may save the file to the external storage 120 via the Internet access unit 425. The file may be saved by any other means

### <Flow of Overall Processing>

Processing described hereinafter is implemented with the CPU 211 of the MFP 110 reading out the control program stored in the ROM 212 and the HDD 214 to the RAM 213 and controlling overall the operations of the units of the MFP 110.

In the present embodiment, saving destination information and a file name generation rule (a generation rule) corresponding to each document type are set in advance by operations of a manager and the user and saved in the HDD 214 or the external storage 120. The saving destination information is information indicating a place to save the file and may include the folder path and a URL of the external storage. Any other information may be included.

The file name generation rule is a rule for setting the file name using the keyword. For example, the file name rule is a rule for setting the file name formed of “{company name}-{document number}-Yamada” and the like. {Company name} and {document number} are placeholders that are replaced with the keyword extracted by extraction processing of the keyword described later. For example, in a case where the keyword extracted as the keyword label “company name” is “Iroha company limited,” and the keyword extracted as the keyword label “document number” is “001,” the file name is “Iroha company limited-001-Yamada.” Only the keyword label that can be extracted from the corresponding document type can be designated to the placeholder, and any character may be set to the file name other than the placeholder

The main processing unit 421 may obtain and hold the saving destination information and the file name generation rule via the internal data saving unit 412 and may obtain and save the saving destination information and the file name generation rule via the Internet access unit 425. The saving destination information and the file name generation rule may be obtained and saved by any other means.

### <Processing Executed by MFP>

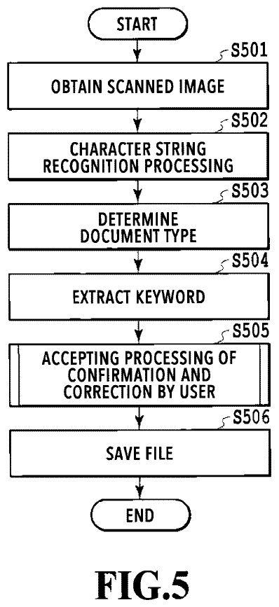

FIG. 5 is a flowchart illustrating a flow of the processing executed by the MFP 110 In FIG. 5, the file name is automatically generated from the scanned image obtained by scanning the document by the MFP 110, and the scanned image is saved with the generated file name. Note that although an example in which the displaying control unit 427 displays the UI screen on the touch panel of the operation unit 220 is described in the present embodiment, it is not limited thereto. The displaying control unit 427 may provide each UI screen of the present embodiment to another apparatus, and an operation unit of the other apparatus may display each UI screen.

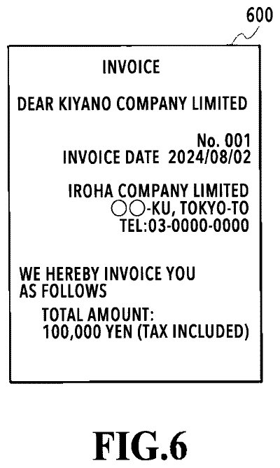

In S501, the main processing unit 421 requests the scanning instruction unit 426 to perform scanning and allows the scanning execution unit 411 to execute the scanning processing on the document set on the automatic original document reading apparatus. Then, the main processing unit 421 obtains the image data (the scanned image data) that is a scanning processing result by the scanning execution unit 411 and saves the image data in the RAM 213. The scanned image obtained in this process is an image of a page unit. The main processing unit 421 obtains the scanned image data obtained by scanning a document 600 illustrated in FIG. 6, for example.

In S502, the main processing unit 421 requests the image processing unit 422 to perform character string recognition processing. The image processing unit 422 obtains the image data saved in S501 from the RAM 213 and generates corrected image data by correcting incline and rotation of the image data. Subsequently, the image processing unit 422 executes the block selection (BS) processing on the corrected image data to detect a character string region (a character string block) corresponding to the character string and executes the character recognition (OCR) processing on the character string region. The generated corrected image data, the character string region as a BS processing result, and the character string as an OCR processing result are saved in the RAM 213.

In S503, the main processing unit 421 requests the document type determination unit 423 to determine the document type. The document type determination unit 423 determines the document type by using the corrected image data, the character string region, and the character string obtained in S502.

In S504, the main processing unit 421 requests the keyword extraction unit 424 to extract the keyword. The keyword extraction unit 424 extracts the keyword by using the character string region and the character string obtained by the detection and the like in S502 and the document type determined in S503. The extracted keyword is saved in the RAM 213. Note that the keyword extraction unit 424 may extract the keyword that can be extracted from all the document types. In a case where only the keyword that can be extracted from the document type determined in S503 is extracted, and the document type is corrected on a correction screen described later, the keyword that can be extracted from the corrected document type may be extracted again. The keyword may be extracted in any other order.

In S505, the main processing unit 421 requests the displaying control unit 427 to display the UI screen to accept confirmation and correction by the user. The displaying control unit 427 generates the UI screen by using the document type determined in S503 and the keyword extracted in S504 and displays the UI screen on the touch panel of the operation unit 220. Additionally, once the user operation on a next button (a save button) described later is accepted on the UI screen, the displaying control unit 427 determines property information shown on the UI screen. The property information includes the saving destination information indicating a saving destination of the scanned image, the file name of the scanned image, and the document type; however, the property information may at least include the saving destination information and the file name of the scanned image.

### <Accepting Processing of Confirmation and Correction by User>

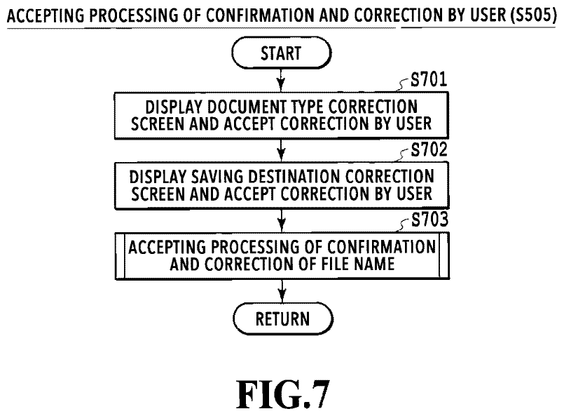

FIG. 7 is a flowchart illustrating a detailed flow of accepting processing of the confirmation and the correction by the user (S505).

In S701, the displaying control unit 427 generates and displays a document type correction screen on which the document type can be designated. Then, the display control unit 427 accepts the correction by the user via the displayed document type correction screen.

### <Document Type Correction Screen>

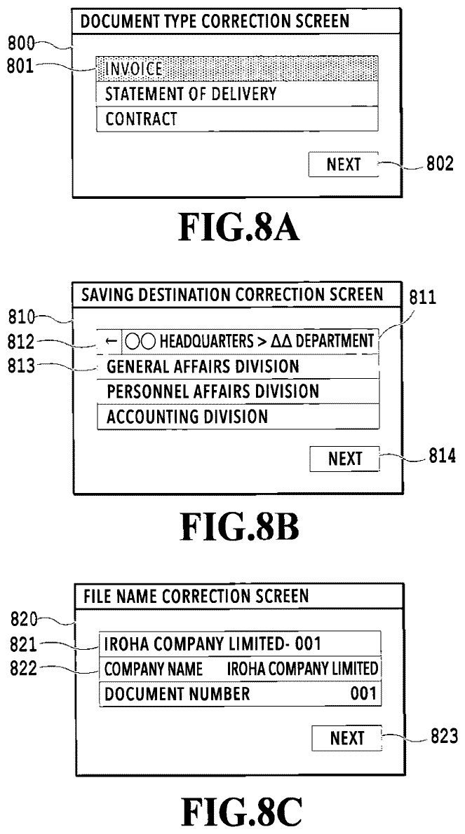

FIG. 8A is a diagram illustrating a document type correction screen example. A document type correction screen 800 is a UI screen in a state in which the user can correct the document type. The document type correction screen 800 displays a document type list 801 and a next (transition) button 802. Note that the document type correction screen 800 may display information that needs to be confirmed by the user in a case of saving the file. The document type correction screen 800 may display any other configuration

The document type list 801 indicates a list of candidates of the document type that can be designated by the user. Note that in FIG. 8A, any one of invoice, statement of delivery, and contract can be designated in the document type list 801. By default, “invoice” that is the document type determined in S503 is designated. The displaying control unit 427 designates the document type that is pressed by the user in the list of the document types. The document type list 801 may display the document type by sorting in the descending order of the certainty.

The next button 802 is a button to transition to the subsequent screen. In a case where the next button 802 is pressed by the user, the correction is reflected, and the displaying control unit 427 updates the saving destination information and the file name to that corresponding to the document type designated on the document type correction screen 800. The saving destination information and the file name after the update are saved in the RAM 213. Specifically, in a case where the document type is corrected on the document type correction screen 800, based on the designated document type after the correction, the saving destination information is identified and the file name is generated again. Then, in S702 described later, a saving destination correction screen in which the identified new saving destination information is inputted is displayed. Then, in S703 described later, a file name correction screen in which the generated new file name is inputted is displayed. That is, the new file name that is generated according to the file name generation rule associated with the document type after the correction, which is different from the file name generation rule associated with the document type before the correction, is displayed on the file name correction screen. Additionally, an alert message to confirm whether to save may be displayed before saving, and saving may be performed in a case of saving in response to the pressing by the user, and saving may not be performed in a case of not saving. Once the user presses the next button 802, the processing proceeds to S702.

Referring back to the description of FIG. 7. In S702, the displaying control unit 427 generates and displays the saving destination correction screen on which the saving destination information can be designated. Then, the display control unit 427 accepts the correction by the user via the displayed saving destination correction screen.

### <Saving Destination Correction Screen>

FIG. 8B is a diagram illustrating a saving destination correction screen example. A saving destination correction screen 810 is a UI screen in a state in which the user can correct the character string used in the saving destination information. The saving destination correction screen 810 displays a folder path item 811, a parent folder button 812, a folder list 813, and a next (transition) button 814. Note that the saving destination correction screen 810 may include information of another external storage, or any other configuration may be applied.

The folder path item 811 is an item to display the folder path of the saving destination information. By default, the display control unit 427 refers to the saving destination information held by the main processing unit 421 and displays the saving destination information corresponding to the document type designated on the document type correction screen 800.

The parent folder button 812 is a button to change the folder path to a folder layer immediately above. In a case where the pressing by the user is received, the displaying control unit 427 changes the folder path of the saving destination information to the layer immediately above. For example, in a case where the current folder path of the saving destination information is “/∘∘ headquarters/ΔΔ department,” the folder path is changed to “/∘∘ headquarters.

The folder list 813 indicates a list of candidates of the folder in the folder path of the saving destination information that can be designated by the user. In a case where the pressing by the user is received, the displaying control unit 427 changes the folder path of the saving destination information to the designated folder. For example, in a case where the folder path of the saving destination information before the designation by the user is performed is “∘∘ headquarters/ΔΔ department” and the user designates “general affairs division,” the folder path is changed to “/∘∘ headquarters/ΔΔ department/general affairs division.” Note that the folder list 813 displays the folder corresponding to the folder path indicated in the folder path item 811. In a case where the parent folder button 812 is pressed by the user, the folder list 813 displays the folder corresponding to the layer immediately above.

The next button 814 is a button to transition to the subsequent screen. In a case where the next button 814 is pressed by the user, the correction is reflected, and the displaying control unit 427 updates the saving destination information to that designated on the saving destination correction screen 810. Once the user presses the next button 814, the processing proceeds to S703.

Referring back to the description of FIG. 7. In S703, the displaying control unit 427 generates and displays the file name correction screen on which the file name can be designated according to a processing result of the extraction processing of the keyword in S504 described above. Then, the display control unit 427 accepts the correction by the user via the displayed file name correction screen. However, in a case where the extraction processing of the keyword succeeds, the display control unit 427 generates and displays the file name correction screen corresponding to the success of the extraction processing of the keyword. On the other hand, in a case where the extraction processing of the keyword fails, the display control unit 427 generates and displays the file name correction screen corresponding to the failing of the extraction processing of the keyword.

<File Name Correction Screen in Case where Extraction Processing of Keyword Succeeds>

FIG. 8C is a diagram illustrating a file name correction screen example in a case where the extraction processing of the keyword succeeds. A file name correction screen 820 is a UI screen in a case where the extraction processing of the keyword succeeds, which is the UI screen in a state in which the user can correct the character string used in the file name of the scanned image. The file name correction screen 820 displays a file name item 821, a keyword list 822, and a next (transition) button 823. Note that the file name correction screen 820 may display any other configuration.

The file name item 821 is an item to display the character string forming the file name. By default, the display control unit 427 refers to the file name generation rule held by the main processing unit 421 and generates and displays the file name according to the file name generation rule corresponding to the document type designated on the document type correction screen 800 Specifically, the display control unit 427 generates and displays the file name by replacing the placeholder of the file name generation rule with a corresponding keyword from the keywords extracted in S504. In FIG. 8C, “Iroha company limited-001” is displayed. In a case where the pressing by the user is received, the displaying control unit 427 corrects the file name. For example, the displaying control unit 427 may correct the file name to that formed of a free word inputted by utilizing a software keyboard (not illustrated). In a case where the keyword is deleted during the correction of the file name, the corresponding keyword is deleted from a keyword list described later. Additionally, a new placeholder of the keyword may be added. In a case where the placeholder of the keyword is added during the correction of the file name, the keyword added as the corresponding placeholder is added to the keyword list described later. The file name item 821 may be corrected by any other means.

The keyword list 822 is a list indicating the list of the multiple keywords forming the file name. In FIG. 8C, “Iroha company limited” is displayed as the company name, and “001” is displayed as the document number. In a case where the pressing by the user is received, the displaying control unit 427 corrects the corresponding keyword For example, a candidate of the keyword may be displayed to correct the keyword to that designated by the user, or the keyword may be corrected to that formed of the free word inputted by the user. The keyword indicated in the keyword list 822 may be corrected by any other means. Once the keyword is corrected, the correction is reflected, and the displaying control unit 427 updates the corresponding keyword in the file name item 821.

The next button 823 is a button to execute saving with the file name being displayed. In a case where the next button 823 is pressed by the user, the correction is reflected, and the displaying control unit 427 determines the file name with the contents being displayed on the file name correction screen 820. In a case where the next button 823 is pressed by the user, the flow illustrated in FIG. 7 ends, and the processing proceeds to S506.

<File Name Correction Screen in Case where Extraction Processing of Keyword Fails>

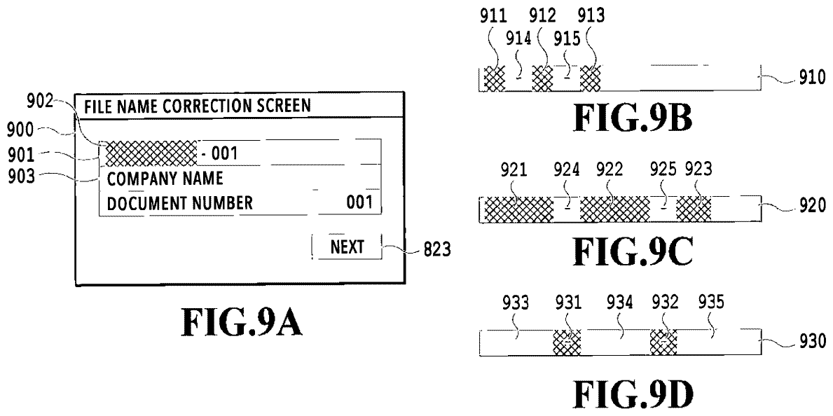

FIGS. 9A to 9D are diagrams describing a file name correction screen example in a case where the extraction processing of the keyword fails. FIG. 9A illustrates the file name correction screen example in a case where the extraction processing of the keyword fails. FIGS. 9B to 9D illustrate pattern examples of the file name item. Note that a difference from the file name correction screen 820 is mainly described. A file name correction screen 900 is a UI screen in a case where the extraction processing of the keyword fails, which is the UI screen in a state in which the user can correct the character string used in the file name of the scanned image. The file name correction screen 900 displays a file name item 901, a keyword list 903, and the next (transition) button 823. Note that the file name correction screen 900 may display any other configuration.

The keyword list 903 is a list indicating the list of the multiple keywords used in the file name. In FIG. 9A, a blank is displayed for the company name since the extraction of the keyword related to the company name fails, and “001” is displayed for the document number since the extraction of the keyword related to the document image succeeds.

As with the file name item 821, the file name item 901 is an item to display the character string forming the file name. However, in the file name item 901, since the extraction of the keyword related to the company name fails, a background of a portion 902, which is a portion corresponding to the item of the company name and hatched in FIG. 9A, is colored and displayed. The display of the file name item 901 is not limited to the configuration illustrated in FIG. 9A. For example, in a case where the file name is formed of three types of the character strings, and the extraction of the keyword corresponding to the three types of the character strings fails, a file name item 910 illustrated in FIG. 9B, a file name item 920 illustrated in FIG. 9C, and a file name item 930 illustrated in FIG. 9D may be displayed.

The file name item 910 is an example to respectively display portions 911, 912, and 913, which indicate the character string corresponding to the item that fails the extraction of the keyword, as blanks having the background color in the same width while inserting delimiter characters 914 and 915 based on the portions 911, 912, and 913. With the same width, it is possible to confirm the number of missing keywords even in a case of a small display screen.

The file name item 920 is an example to respectively display portions 921, 922, and 923, which indicate the character string corresponding to the item that fails the extraction of the keyword, as blanks having the background color in different widths according to the number of the characters of the keyword that fails to be extracted.

Additionally, delimiter characters 924 and 925 are inserted and displayed based on the portions 921, 922, and 923. With the widths changed according to the number of the characters of the keyword, it is possible to confirm which keyword fails to be extracted based on the size of the width.

The file name item 930 is an example to display inserted delimiter characters 931 and 932 by applying the background color. With the background color applied to the delimiter character, it is possible to confirm whether there is a missing keyword in the character string forming the file name before and after the delimiter character. In the present embodiment, an example in which the background of the delimiter character is colored is described; however, it is not limited thereto. The delimiter character may be displayed in a highlighted manner by changing a character color of the delimiter character or changing the thickness of the delimiter character, for example, or may be displayed by other means.

A displaying method of the file name items 901, 910, 920, and 930 may be changeable by setting or may not be changeable by setting to maintain a particular state.

### <Accepting Processing of Confirmation and Correction of Pile Name>

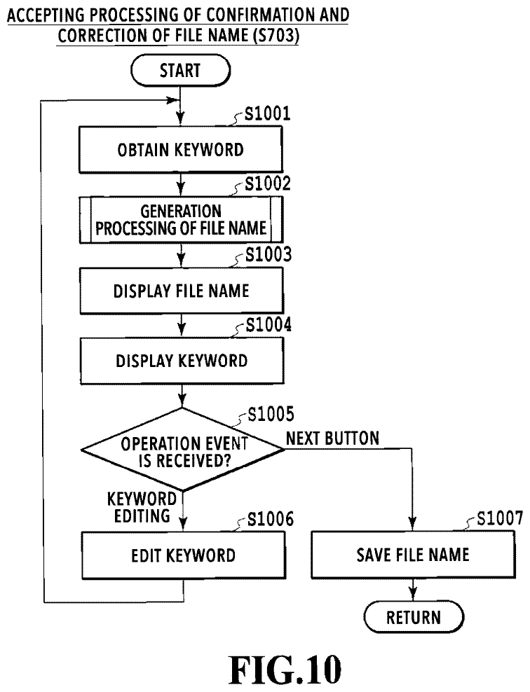

FIG. 10 is a flowchart illustrating a detailed flow of the accepting processing of the confirmation and the correction of the file name (S703).

In S1001, the display control unit 427 obtains the keyword extracted in S504 and the file name generation rule from the RAM 213.

In S1002, the display control unit 427 generates the file name by using the keyword obtained in S1001 according to the file name generation rule obtained in S1001.

### <Generation Processing of File Name>

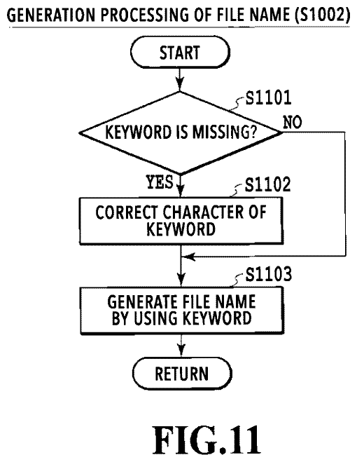

FIG. 11 is a flowchart illustrating a detailed flow of the generation processing of the file name (S1002).

In S1101, the display control unit 427 determines whether the keyword is missing based on the keyword and the file name generation rule obtained in S1001. For example, it is assumed that the file name generation rule is “{company name}-{document number},” and the keyword is “document number:001.” In this case, since the obtained keyword does not include the character string that meets the file name generation rule, it is determined that the keyword corresponding to {company name} of the file name generation rule is missing. If it is determined that the keyword is missing (YES in S1101), the processing proceeds to S1102. If it is determined that no keyword is missing (NO in S1101), S1102 is skipped, and the processing proceeds to S1103.

In S1102, the display control unit 427 corrects the character string of the keyword. The correction of the character of the keyword utilizes a character string with a tag to distinguish whether to display the character string with a background color in a case where the display control unit 427 displays the character string on the file name correction screen. For example, the displayed character string is surrounded by a span tag like “<span style=“background-color:#ffa500”>□□□</span>,” and the background color of the character surrounded by the span tag is designated by a style element. In a case where the tag of the example is executed, the background color in orange color is displayed in three two-byte spaces (portions of □□□). #ffa500 indicates a value of RGB that indicates the component of the color. In the present embodiment, the tag is utilized as a correction example of the character of the keyword; however, another method may be applied.

In S1103, the display control unit 427 generates the file name by using the keyword according to the file name generation rule obtained in S1001. The generated file name is saved in the RAM 213. In the present embodiment, the file name generation rule is “{company name}-{document number},” the keyword is “document number:001,” and the correction of the character of the keyword is “<span style=“background-color:#ffa500”>□□□</span>.” Therefore, the file name generated by using the keyword is “<span style=“background-color:#ffa500”>□□□</span>-001.”

Referring back to the description of FIG. 10. In S1003, the display control unit 427 obtains the file name generated in S1002 from the RAM 213 and displays the file name. The display control unit 427 construes the tag included in the file name and displays the background color and the character string in the file name item 821.

In S1004, the display control unit 427 displays the keyword in a keyword list 903.

In S1005, the display control unit 427 determines whether a received pressing event by the user is keyword editing. If it is determined that the keyword editing is received (keyword editing in S1005), the processing proceeds to S1006. In S1006, the display control unit 427 edits the keyword. The editing of the keyword may be, for example, filling in the free word. Any other means may be applied. Once the processing in S1006 ends, the processing proceeds to S1001.

On the other hand, if it is determined that the next button is received (next button in S1005), the processing proceeds to S1007. In S1007, the display control unit 427 saves the file name displayed in the file name item in the RAM 213, and the flow illustrated in FIG. 10 ends.

The file name to be saved may be the file name that is displayed in the file name item and saved with no change, or the file name may be saved by deleting the space. For example, in a case where the character string displayed in the file name item is “−001,” the file name may be saved as “−001” with no change, or the spaces may be deleted to be saved as “−001.” In some cases, the delimiter character may not be noticed as the first character; for this reason, the file name may be saved as “−011” by leaving only one space, or the spaces and the delimiter character may be deleted to be saved as “001.”

Referring back to the description of FIG. 5. In S506, the mam processing unit 421 requests the file saving unit 428 to save the file. The file saving unit 428 obtains the file saving information (the folder path of the saving destination saved in S702 and the file name saved in S1007) determined in S505 from the RAM 213. The file saving unit 428 obtains the corrected image data generated in S502 from the RAM 213. Then, the file saving unit 428 saves the file with the designated file name in the folder path of the designated saving destination information by using the file saving information determined in S505. Additionally, in a case where the saving destination information indicates the external storage 120, the file saving unit 428 saves the file in the external storage via the internet access unit 425.

As described above, in the present embodiment, the failing of the extraction of the keyword is detected based on the file name generation rule and the extracted keyword. In addition, the file name correction screen, which shows the file name to which the information indicating the detected failing of the extraction of the keyword is added for each keyword that fails to be extracted, is displayed. Therefore, it is possible to allow the user to figure out whether the file name of the scanned image that is the property information of the file automatically generated is that intended by the user. With the user figuring out the file name as described above, it is possible to increase the possibility that the file name is generated by using the extracted character string intended by the user, and it is possible to improve the convenience for the user. Additionally, since the portion that prompts the user to confirm is indicated, work of the confirmation is reduced, and it is possible to improve the operability for the extraction result of the character string.

Incidentally, although the technique of Japanese Patent Laid-Open No. 2019-115011 is considered to be used for the filing of the document, there has been a possibility that the character string that meets the extraction rule is not obtained, and the user performs setting without noticing that the file name intended by the user is not generated. In a case where the file name that is not intended by the user is generated as described above, it is a problem that the file name is set without the user recognizes. In addition, the above-described problem occurs not only in the generation of the file name but may also occur similarly in a case of generating the property information of the file by using the character string extracted from the scanned image such as a case of generating the folder path, for example.

According to the present embodiment, the user can figure out whether the property information of the file automatically generated is intended by the user.

### Second Embodiment

In the present embodiment, an aspect in which an alternative character string is displayed in a case where the extraction of the keyword fails is described. In the present embodiment, it is assumed that a default character string is set in advance. For example, in a case where all the keywords are missing, “NoKeyword” may be applied, and setting of the default character string may be held for each type of the missing keywords. For example, “COMPANY” is held for the company name, and “DOCUMENTID” is held for the document number. In the present embodiment, descriptions are provided assuming that the keyword of the company name is missing, and “COMPANY” is saved in advance in the RAM 213 as the default character string of the company name. Note that in the present embodiment, a difference from the embodiment 1 is mainly described.

### (File Name Correction Screen in Case of Failing Extraction Processing of Keyword)

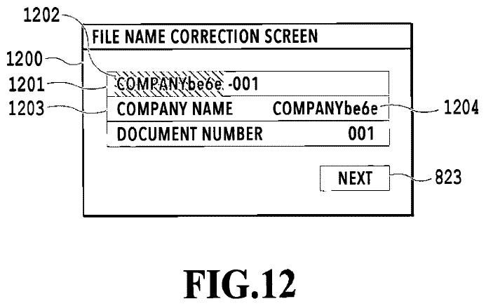

FIG. 12 is a diagram illustrating a file name correction screen example in a case of failing the extraction processing of the keyword. A file name correction screen 1200 is a UI screen in a case of failing the extraction processing of the keyword, which is the UI screen in a state in which the user can correct the character string used in the file name of the scanned image. The file name correction screen 1200 displays a file name item 1201, a keyword list 1203, and the next (transition) button 823.

The keyword list 1203 is a list indicating the list of the multiple keywords used in the file name. In FIG. 12, COMPANYbe6e that is an alternative character string 1204 of the company name is displayed since the extraction of the keyword related to the company name fails, and “001” is displayed as the document number since the extraction of the keyword related to the document image succeeds.

As with the file name item 821, the file name item 1201 is an item to display the character string forming the file name. However, in the file name item 1201, a background of a portion 1202, which is a hatched portion in FIG. 12 corresponding to the item of the company name that fails the keyword extraction, is colored and displayed, and the alternative character string is displayed.

### <Generation Processing of File Name>

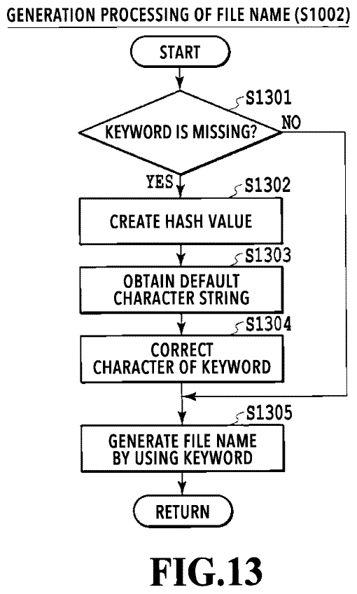

FIG. 13 is a flowchart illustrating a detailed flow of the generation processing of the file name in the present embodiment (S1002).

In S1301, the display control unit 427 determines whether the keyword is missing based on the keyword and the file name generation rule obtained in S1001. For example, it is assumed that the file name generation rule is “{company name}-{document number},” and the keyword is “document number:001.” In this case, since the obtained keyword does not include the character string that meets the file name generation rule, it is determined that the keyword corresponding to {company name} of the file name generation rule is missing. If it is determined that the keyword is missing (YES in S1301), the processing proceeds to S1302. If it is determined that no keyword is missing (NO in S1301), S1302 to S1304 are skipped, and the processing proceeds to S1305.

In S1302, the display control unit 427 obtains the corrected image data generated in S502 from the RAM 213 and executes a hash function on the obtained corrected image data to generate a hash value. In the present embodiment, the hash value is a unique character string generated by executing the hash function. In the present embodiment, the first four characters “be6e” of the generated hash value are utilized; however, the entire hash value may be utilized, or the character string to be utilized may be increased or decreased by dragging the hash value on the UI screen. A method of creating the unique character string is not limited thereto, and another method may be applied

In S1303, the display control unit 427 obtains the default character string “COMPANY” that is a predetermined character string set by default from the RAM 213.

In S1304, the display control unit 427 corrects the character of the keyword. The display control unit 427 corrects the character of the keyword by combining the hash value “be6e” obtained in S1302 and the default character string “COMPANY” obtained in S1303. The correction of the character of the keyword is the character string with the tag to distinguish whether to display the character string with the background color in a case where the display control unit 427 displays the character string on the screen. For example, the displayed character string is surrounded by the span tag like “<span style=“background-color:#ffff00”>COMPANYbe6e</span>,” and the background color of the character surrounded by the span tag is designated by the style element. In a case where the tag of the example is executed, the background color in yellow color is displayed in “COMPANYbe6e”. #ffff00 indicates a value of RGB that indicates the component of the color. In the present embodiment, the tag is utilized as a correction example of the character of the keyword; however, another method may be applied.

In S1305, the display control unit 427 generates the file name by using the keyword according to the file name generation rule obtained in S1001. The generated file name is saved in the RAM 213. In the present embodiment, the file name generation rule is “{company name}-{document number}.” The keyword is “document number:001.” The correction of the character of the keyword is “<span style=“background-color:#ffff00”>COMPANYbe6e</span>.” Therefore, the file name generated by using the keyword is “<span style=“background-color:#ffff00”>COMPANYbe6e</span>-001.”

As described above, in the present embodiment, in a case where the extraction of the keyword fails, the file name correction screen showing the alternative character string is displayed. Thus, it is possible to save the file without editing the keyword by the user, and it is possible to improve the convenience. Additionally, since the unique character string is applied to the alternative character string, the file name does not overlap with the file name of an already-existing file, and overwriting of the already-existing file does not occur; therefore, it is possible to further improve the convenience.

### Third Embodiment

In the present embodiment, an aspect in which, in a case where the extraction of the keyword succeeds, position information of the extracted character string is held, and the extraction of the keyword fails in the subsequent scanned image, the character string in the same position as the position information of the previous (past) character string is obtained, and the alternative character string is displayed is described. In the present embodiment, a difference from the embodiment 1 is mainly described.

### <Processing Executed by MFP>

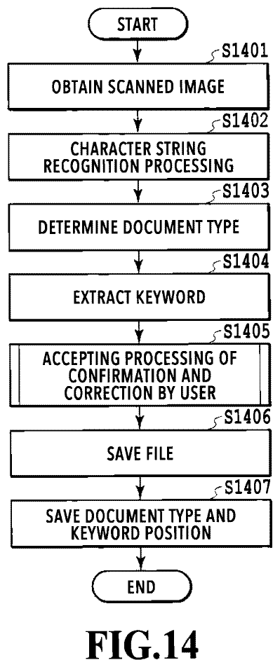

FIG. 14 is a flowchart illustrating a flow of the processing executed by the MFP 110. In FIG. 14, the file name is automatically generated from the scanned image obtained by scanning the document by the MFP 110, and the scanned image is saved with the generated file name.

In S1401, the main processing unit 421 requests the scanning instruction unit 426 to perform scanning and allows the scanning execution unit 411 to execute the scanning processing on the document set on the automatic original document reading apparatus. Then, the main processing unit 421 obtains the image data (the scanned image data) that is the scanning processing result by the scanning execution unit 411 and saves the image data in the RAM 213.

In S1402, the main processing unit 421 requests the image processing unit 422 to perform the character string recognition processing. The image processing unit 422 obtains the image data saved in S1401 from the RAM 213 and generates the corrected image data by correcting incline and rotation of the image data. Subsequently, the image processing unit 422 executes the block selection (BS) processing on the corrected image data to detect the character string region (the character string block) corresponding to the character string and executes the character recognition (OCR) processing on the character string region. The generated corrected image data, the character string region as the BS processing result, and the character string as the OCR processing result are saved in the RAM 213. Examples of extraction results of the character string region and the character string in the present embodiment are indicated in a list of result information of the character string region and the character string in a case of saving the history in which history information is saved. In the list of the result information of the character string region and the character string, the character string regions are “(1079,436), (282,45),” “(584,670), (276,30),” and “(1873,916), (108,23).”

The character strings corresponding to the character string regions are “invoice,” “Iroha company limited,” and “001.”

TABLE 1
List of Result Information of Character String Region
and Character String in Case of Saving History

| character string region (origin xy | |
|---|---|
| coordinate, width, height) | character string |
| (1079, 436), (282, 45) | invoice |
| (584, 670), (276, 30) | Iroha company limited |
| (1873, 916), (108, 23) | 001 |

In S1403, the main processing unit 421 requests the document type determination unit 423 to determine the document type. The document type determination unit 423 obtains the corrected image data and the character string region obtained in S1402 from the RAM 213 and determines the document type by using the character string region and the character string. The determined document type is saved in the RAM 213.

In S1404, the main processing unit 421 requests the keyword extraction unit 424 to extract the keyword. The keyword extraction unit 424 obtains the character string region and character string obtained in S1402 and the document type determined in S1403 from the RAM 213. Then, the keyword is extracted based on the character string region, the character string, and the document type. The extracted keyword is saved in the RAM 213. An example of an extraction result of the keyword in the present embodiment is indicated in a list of extraction result information of the keyword in a case of saving the history. In the list of the extraction result information of the keyword, the keywords are “company name” and “document number.” The character strings corresponding to the keywords are “Iroha company limited” and “001.” As for the character string “invoice,” the keyword is blank and this indicates that no keyword is extracted.

TABLE 2
History List of Extraction Result Information
of Keyword in Case of Saving

| keyword | character string |
|---|---|
| | invoice |
| company name | Iroha company limited |
| document number | 001 |

In the present embodiment, the keyword that can be extracted from all the document types is extracted, however, it is not limited thereto. Only the keyword that can be extracted from the document type determined in S1403 may be extracted, and once the document type is corrected on a correction screen described later, the keyword that can be extracted from the corresponding document type may be extracted again. The keyword may be extracted in any other order.

In S1405, the main processing unit 421 requests the display control unit 427 to display the UI screen to accept the confirmation and the correction by the user. The display control unit 427 generates the UI screen by using the document type determined in S1403 and the keyword extracted in S1404 and displays the UI screen on the touch panel of the operation unit 220. Additionally, once the user operation on the next button (the save button) is accepted on the UI screen, the display control unit 427 determines the property information shown on the UI screen.

In S1406, the main processing unit 421 requests the file saving unit 428 to save the file. The file saving unit 428 obtains the file saving information (the folder path of the saving destination saved in S702 and the file name saved in S1007) determined in S1405 from the RAM 213. The file saving unit 428 obtains the corrected image data generated in S1402 from the RAM 213. Then, the file saving unit 428 saves the file with the designated file name in the folder path of the designated saving destination information by using the file saving destination information determined in S1405. Additionally, in a case where the saving destination information indicates the external storage 120, the file saving unit 428 saves the file in the external storage via the internet access unit 425.

In S1407, the main processing unit 421 requests the keyword extraction unit 424 to save the document type and the keyword position. The keyword extraction unit 424 obtains the document type determined in S1403, the keyword extracted in S1404, and the character string region that is corresponding to the keyword and extracted in S1402 from the RAM 213 and saves the information in the RAM 213 in association with each other as the history information. Examples of the document type and an extraction result of the keyword in the present embodiment and a result of the character string region are indicated in a list of history information of extraction result of the keyword. In the list of the history information of the extraction result of the keyword, the document type is “invoice,” the keywords are “company name” and “document number,” and the character string regions are “(584,670), (276,30)” and “(1873,916), (108,23).”

TABLE 3
List of History Information of Extraction Result of Keyword

| | | character string region |
|---|---|---|
| | | (origin xy coordinate, width, |
| document type | keyword | height) |
| invoice | company name | (584, 670), (276, 30) |
| | document number | (1873, 916), (108, 23) |

### <Generation Processing of File Name>

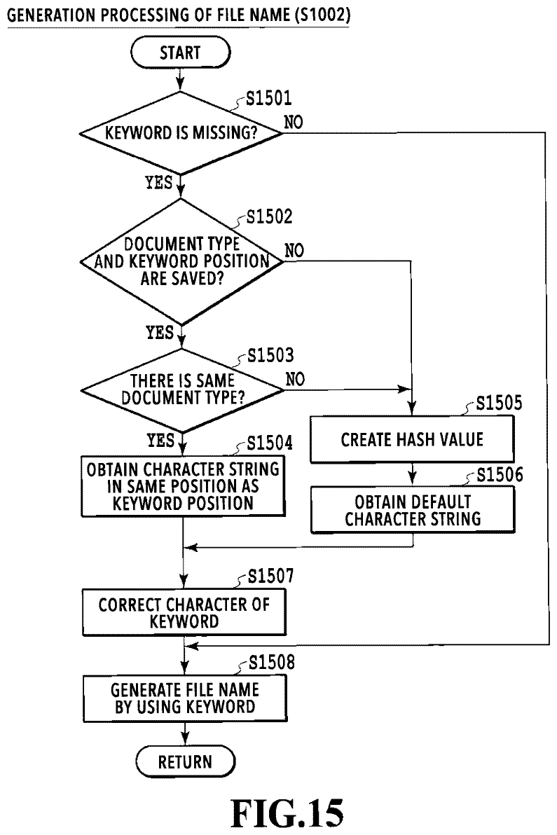

FIG. 15 is a flowchart illustrating a flow of the processing of generating the file name in the present embodiment. Examples of the extraction results of the character string region and the character string in the present flowchart example are indicated in a list of result information of the character string region and the character string. In the list of the result information of the character string region and the character string, the character string regions are “(1079,436), (282,45),” “(584,670), (276,30),” and “(1873,916), (108,23).” The character strings corresponding to the character string regions are “invoice,” “Iroha company limited,” and “002.”

TABLE 4
String List of Result Information of
Character String Region and Character

| character string region (origin xy | |
|---|---|
| coordinate, width, height) | character string |
| (1079, 436), (282, 45) | invoice |
| (584, 670), (276, 30) | Iroha company limited |
| (1873, 916), (108, 23) | 002 |

An extraction result of the keyword in the present flowchart example is indicated in a list of extraction result information of the keyword. In the list of the extraction result information of the keyword, the keyword is “document number,” and the character string corresponding to the keyword is “002.”

TABLE 5
List of Extraction Result Information of Keyword

| keyword | character string |
|---|---|
| | invoice |
| | Iroha company limited |
| document number | 002 |

In S1501, the display control unit 427 determines the missing keyword based on the keyword and the file name generation rule obtained in S1001. For example, it is assumed that the file name generation rule is “{company name}-{document number},” and the keyword is “document number:002.” In this case, since the obtained keyword does not include the character string that meets the file name generation rule, it is determined that the keyword corresponding to {company name} of the file name generation rule is missing. If it is determined that the keyword is missing (YES in S1501), the processing proceeds to S1502. If it is determined that no keyword is missing (NO in S1501), S1502 to S1507 are skipped, and the processing proceeds to S1508.

In S1502, the display control unit 427 obtains the document type and the extraction result of the keyword and the result of the character string region saved in S1407 from the RAM 213 and determines whether there is a result. If it is determined there are no extraction result of the keyword and no result of the character string region (NO in S1502), and the processing proceeds to S1505. If it is determined that there are the document type and the extraction result of the keyword and the result of the character string region (YES in S1502), the processing proceeds to S1503.

In S1503, the display control unit 427 obtains the document type saved in S702 from the RAM 213 and determines whether the document type is included in the document type and the extraction result of the keyword and the result of the character string region obtained in S1502. If it is determined that the document type is not included (NO in S1503), the processing proceeds to S1505. If it is determined that the document type is included in the document type and the extraction result of the keyword and the result of the character string region (YES in S1503), the processing proceeds to S1504.

In S1504, the display control unit 427 obtains the character string region corresponding to the keyword that is the missing keyword and obtains the character string corresponding to the same character string region. In the present embodiment, since the company name is missing, the character string region “(584,670), (276,30)” corresponding to the document type “invoice” and the keyword “company name” is obtained from the document type and the extraction result of the keyword and the result of the character string region. “Iroha company limited” is obtained as the character string corresponding to the obtained character string region “(584,670), (276,30)” from the list of the result information of the character string region and the character string. In the present embodiment, an example in which the character string that corresponds to both the character string region in the list of the history information of the extraction result of the keyword and the character string region in the list of the result information of the character string is described; however, the character string that corresponds to the close character string regions, not the same, may be obtained. For example, a method of confirming the overlap between the character string regions and obtaining the character string corresponding to the regions that overlap each other the most may be applied, or another method may be applied

In S1505, the display control unit 427 obtains the corrected image data generated in S502 from the RAM 213 and executes the hash function on the obtained corrected image data to generate the hash value. In the present embodiment, the hash value is the unique character string generated by executing the hash function. In the present embodiment, the first four characters “be6e” of the generated hash value is utilized; however, the entire hash value may be utilized, or the character string to be utilized may be increased or decreased by dragging the hash value on the UI screen. The method of creating the unique character string is not limited thereto, and another method may be applied.

In S1506, the display control unit 427 obtains the default character string “COMPANY” that is the predetermined character string set by default from the RAM 213.

In S1507, the display control unit 427 corrects the character of the keyword. The display control unit 427 corrects the character of the keyword based on the character string “Iroha company limited” obtained in S1504 or the character string obtained by combining the hash value “be6e” obtained in S1505 and the default character string “COMPANY” obtained in S1506. The correction of the character of the keyword is the character string with the tag to distinguish whether to display the character string with the background color in a case where the display control unit 427 displays the character string on the screen. For example, the displayed character string is surrounded by the span tag like “<span style=“background-color:#ffff00”>Iroha company limited </span>,” and the background color of the character surrounded by the span tag is designated by the style element. In a case where the tag of the example is executed, the background color in yellow color is displayed in “Iroha company limited.” #ffff00 indicates a value of RGB that indicates the component of the color. In the present embodiment, the tag is utilized as a correction example of the character of the keyword; however, another method may be applied.

In S1508, the display control unit 427 generates the file name by using the keyword according to the file name generation rule obtained in S1001. The generated file name is saved in the RAM 213. In the present embodiment, the file name generation rule is “{company name}-{document number}.” The keyword is “document number:002,” and the correction of the character of the keyword is “<span style=“background-color:#ffff00”>Iroha company limited </span>.” Therefore, the file name generated by using the keyword is “<span style=“background-color:#ffff00”>Iroha company limited </span>-002.”

As described above, in the present embodiment, the position information of the character string extracted in a case where the keyword is extracted normally is held. In addition, in a case where the extraction of the keyword fails for the subsequent scanned image, the character string in the same position as the position information of the previous (past) character string is obtained, and the alternative character string is displayed. Thus, it is possible to save the file without editing the keyword by the user, and it is possible to improve the convenience.

### OTHER EMBODIMENTS

In the above descriptions, a case where the property information is the file name, and the file name generation rule is a rule to identify one or more character strings used in the file name is described; however, it is not limited thereto. The present disclosure is also applicable to a case where the property information is the folder path, and the folder name generation rule is a rule to identify one or more character strings and a folder layer structure used for the folder path.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to allow a user to figure out whether property information of a file automatically generated is that intended by the user.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-160102, filed Sep. 17, 2024, which is hereby incorporated by reference herein in its entirety.

What is claimed is:

1. An image processing apparatus that generates property information of a scanned image obtained by scanning a document, the image processing apparatus comprising:
at least one memory that stores instructions; and
at least one processor that executes the instructions to:
obtain one or more character strings obtained by character recognition processing on the scanned image;
generate the property information by using a character string that meets a generation rule of the property information of the scanned image out of the obtained one or more character strings; and
allow a displaying unit to display the property information, wherein
in a case where the obtained one or more character strings do not include the character string that meets the generation rule, in the generating, the property information to which information indicating that the obtainment of the character string that meets the generation rule fails is added is generated.

2. The image processing apparatus according to claim 1, wherein
in the generating, the property information to which a colored background is added as the information is generated.

3. The image processing apparatus according to claim 2, wherein
in the generating, in a case where obtainment of a plurality of the character strings that meet the generation rule fails, the property information in which the colored background that has the same width corresponds to each of the plurality of the character strings that fail to be obtained is generated.

4. The image processing apparatus according to claim 2, wherein
in the generating, in a case where obtainment of a plurality of the character strings that meet the generation rule fails, the property information in which the colored background that has a width according to the number of the character strings corresponds to each of the plurality of the character strings that fail to be obtained is generated.

5. The image processing apparatus according to claim 1, wherein
in the generating, the property information to which a delimiter character is added based on the character string that fails to be obtained is generated.

6. The image processing apparatus according to claim 5, wherein
in the generating, the property information in which the delimiter character is displayed in a highlighted manner is generated.

7. The image processing apparatus according to claim 2, wherein
in the generating, the property information to which an alternative character string as an alternative of the character string that fails to be obtained is added is generated.

8. The image processing apparatus according to claim 7, wherein
the alternative character string is formed of a hash value obtained by executing a hash function on the scanned image and a predetermined character string associated with the character string that fails to be obtained.

9. The image processing apparatus according to claim 1,
wherein the at least processor further executing the instructions to save history information including position information of a character string used in property information of a past scanned image and a document type of the past scanned image, wherein in a case where a document type of the scanned image from which the property information is generated in the generating is the same as the document type of the past scanned image, in the generating, the property information of the scanned image is generated by using a character string corresponding to the position information of the character string included in the history information out of the obtained character string.

10. The image processing apparatus according to claim 1, wherein
the property information is a file name, and
the generation rule is a rule to identify one or more character strings used in the file name.

11. The image processing apparatus according to claim 1, wherein
the property information is a folder path, and
the generation rule is a rule to identify one or more character strings and a folder layer structure used for the folder path.

12. An image processing method that generates property information of a scanned image obtained by scanning a document, the image processing method comprising:
obtaining one or more character strings obtained by character recognition processing on the scanned image;
generating the property information by using a character string that meets a generation rule of the property information of the scanned image out of the one or more character strings obtained in the obtaining; and
allowing a displaying unit to display the property information, wherein
in a case where the one or more character strings obtained in the obtaining do not include the character string that meets the generation rule, in the generating, the property information to which information indicating that the obtainment of the character string that meets the generation rule fails is added is generated.

13. A non-transitory computer readable storage medium storing a program for causing a computer to perform an image processing method that generates property information of a scanned image obtained by scanning a document, the image processing method comprising:
obtaining one or more character strings obtained by character recognition processing on the scanned image;
generating the property information by using a character string that meets a generation rule of the property information of the scanned image out of the one or more character strings obtained in the obtaining; and
allowing a displaying unit to display the property information, wherein
in a case where the one or more character strings obtained in the obtaining do not include the character string that meets the generation rule, in the generating, the property information to which information indicating that the obtainment of the character string that meets the generation rule fails is added is generated.
